(19) United States
(12) Patent Application Publication
(10) Pub. No.: US 2018/0302801 A1
(43) Pub. Date: Oct. 18, 2018

(54) COMMUNICATION SYSTEM, MASTER STATION DEVICE, AND COMMUNICATION CONTROL METHOD

(71) Applicants: Kabushiki Kaisha Toshiba, Minato-ku, Tokyo (JP); TOSHIBA INFRASTRUCTURE SYSTEMS & SOLUTIONS CORPORATION, Kawasaki-shi, Kanagawa (JP)

(72) Inventors: Kohta NAKAMURA, Musashino Tokyo (JP); Katsumi KUSAMA, Chofu Tokyo (JP); Taichi TASHIRO, Fuchu Tokyo (JP); Manabu MUKAI, Yokohama Kanagawa (JP); Keiji YAMAMOTO, Ome Tokyo (JP)

(21) Appl. No.: 15/735,148

(22) PCT Filed: Nov. 19, 2015
(86) PCT No.: PCT/JP2015/082577

§ 371 Date: Dec. 8, 2017

(30) Foreign Application Priority Data
Jun. 11, 2015 (JP) 2015-118653

(51) Int. Cl. H04W 16/28; H04W 64/00; H04B 7/10

(52) U.S. Cl. CPC H04W 16/28; H04W 88/085; H04B 7/10; H04W 64/00

(57) ABSTRACT

A communication system according to one embodiment manages wireless communication via an antenna capable of communicating with a plurality of terminals within a predetermined area. The communication system includes an analyzer and a controller. The analyzer is configured to analyze first information and second information and to specify an uncommunicable terminal from the terminals based on an analysis result. The first information is information registered in advance as positional information of the terminals within the predetermined area. The second information is predetermined information acquirable from the terminals. The uncommunicable terminal is a terminal located at a position where communication with the antenna is not possible. The controller is configured to perform antenna control of controlling at least one of an output and orientation of the antenna when there is the uncommunicable terminal, so that the uncommunicable terminal enters a state in which the communication with the antenna is possible.

### FIELD

Embodiments of the present invention relate to a communication system, a master station device, and a communication control method.

### BACKGROUND

Conventionally, there has been known a technique to install in a distributed manner a plurality of antennas used for wireless communication within a predetermined area.

### CITATION LIST

### Patent Literature

Patent Literature 1: Japanese Laid-open Patent Publication No. 2009-182401

Patent Literature 2: Japanese Laid-open Patent Publication No. 8-107382

Patent Literature 3: Japanese Laid-open Patent Publication No. 2014-154964

Patent Literature 4: Japanese Laid-open Patent Publication No. 2014-179734

Patent Literature 5: Japanese Laid-open Patent Publication No. 2013-247500

### SUMMARY OF THE INVENTION

### Problem to be Solved by the Invention

In the conventional technique as described above, there may be a location (region) in which the wireless communication is not possible due to occurrence of, for example, cancellation of phases between output signals from the antennas.

### Means for Solving Problem

A communication system according to one embodiment is configured to manage wireless communication via an antenna capable of communicating with a plurality of terminals within a predetermined area. The communication system includes an analyzer and a controller. The analyzer is configured to analyze first information and second information and to specify an uncommunicable terminal from the terminals based on an analysis result. The first information is information registered in advance as positional information of the terminals within the predetermined area. The second information is predetermined information acquirable from the terminals. The uncommunicable terminal is a terminal located at a position where communication with the antenna is not possible. The controller is configured to perform antenna control of controlling at least one of an output and orientation of the antenna when there is the uncommunicable terminal, so that the uncommunicable terminal enters a state in which the communication with the antenna is possible.

### BRIEF DESCRIPTION OF DRAWINGS

FIG. 1 is an exemplary block diagram illustrating a network configuration of a communication system according to a first embodiment.

FIG. 2 is an exemplary block diagram illustrating an internal configuration of a communication system in the first embodiment.

FIG. 3 is an exemplary diagram illustrating first information in the first embodiment.

FIG. 4 is an exemplary diagram illustrating second information in the first embodiment.

FIG. 5A is an exemplary diagram illustrating a radio wave environment before antenna control is performed in the first embodiment.

FIG. 5B is an exemplary diagram illustrating a radio wave environment after the antenna control is performed in the first embodiment.

FIG. 6 is an exemplary diagram for explaining antenna control in the first embodiment.

FIG. 7 is an exemplary diagram for explaining a method of determining a control target antenna which is a target of the antenna control in the first embodiment.

FIG. 8 is an exemplary sequence diagram illustrating processing performed by the communication system in the first embodiment.

FIG. 9 is an exemplary block diagram illustrating an internal configuration of a communication system according to a second embodiment.

FIG. 10 is an exemplary sequence diagram illustrating processing performed by the communication system in the second embodiment.

FIG. 11 is an exemplary block diagram illustrating an internal configuration of a communication system according to a third embodiment.

FIG. 12 is an exemplary sequence diagram illustrating processing performed by the communication system in the third embodiment.

FIG. 13 is an exemplary block diagram illustrating a network configuration of a communication system according to a modification example.

### DETAILED DESCRIPTION

Hereinafter, a communication system according to some embodiments will be described with reference to the drawings. The communication system, herein, is a system configured to manage wireless communication via an antenna capable of communicating with a plurality of terminals within a predetermined area. In the embodiments, the communication system that has the following configuration is provided.

That is, the communication system according to the embodiments includes an analyzer and a controller. The analyzer is configured to analyze first information and second information and to specify an uncommunicable terminal from the terminals based on an analysis result. The first information is information registered in advance as positional information of the terminals within the predetermined area. The second information is predetermined information acquirable from the terminals. The uncommunicable terminal is a terminal located at a position where communication with the antenna is not possible. The controller is configured to perform antenna control of controlling at least one of an output and orientation of the antenna when there is the uncommunicable terminal, so that the uncommunicable terminal enters a state in which the communication with the antenna is possible.

### First Embodiment

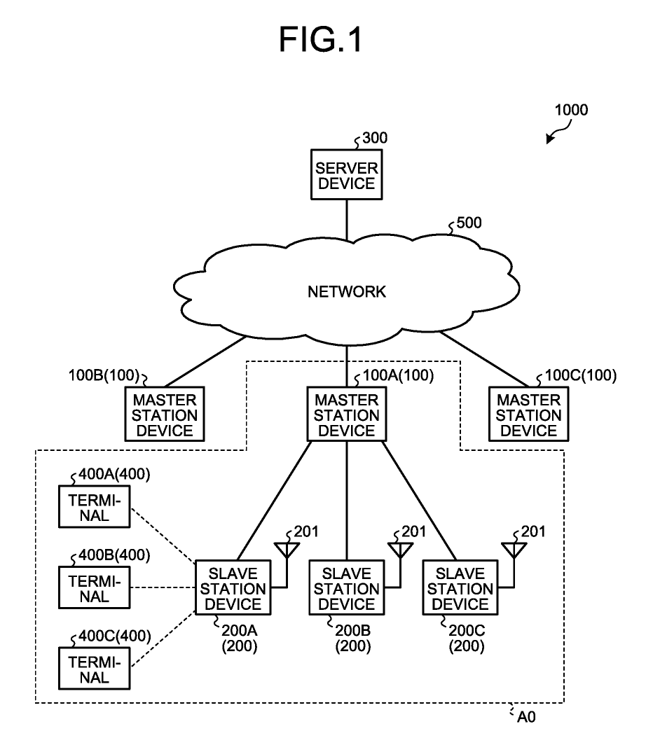

First, a communication system 1000 according to a first embodiment will be described with reference to FIGS. 1 to 8. In the first embodiment, a configuration corresponding to the above-described “analyzer” and “controller” is provided in a master station device 100 of the communication system 1000.

As illustrated in FIG. 1, the communication system 1000 includes the master station devices 100, slave station devices 200, and a server device 300.

The master station device 100 is cable-connected with the slave station devices 200 to be communicable with each other. The master station device 100 is configured to manage communication performed by the slave station devices 200 connected with the master station device 100. Each of the slave station devices 200 includes an antenna 201 and is configured to perform wireless communication with the terminals 400 via the antenna 201. The server device 300 is connected to the master station device 100 via a network 500.

In the first embodiment, the master station devices 100 are provided in plurality. The slave station devices 200 are provided in plurality with respect to each of the master station devices 100. The terminals 400 are provided in plurality with respect to each of the slave station devices 200.

For example, in the example illustrated in FIG. 1, three master station devices 100A to 100C are provided. Three slave station devices 200A to 200C are provided with respect to one master station device 100A. Three terminals 400A to 400C are provided with respect to one slave station device 200A. In FIG. 1, the slave station device 200 connected with the master station devices 100B and 100C, and the terminal 400 performing wireless communication with the slave station devices 200B and 200C are not illustrated. In FIG. 1, three master station devices 100, three slave station devices 200, and three terminals 400 are illustrated as an example, but the numbers of master station devices 100, slave station devices 200, and terminals 400 may be 2 or less or may be 4 or more.

In the example illustrated in FIG. 1, the master station device 100A, the slave station devices 200A to 200C, and the terminals 400A to 400C are provided within the same area A0. That is, in the example illustrated in FIG. 1, the master station device 100A, the slave station devices 200A to 200C, and the terminals 400A to 400C constitute a so-called distributed antenna system (DAS).

The distributed antenna system is a system designed to achieve high quality of wireless communication by distributing and providing a plurality of antennas within a predetermined area. However, in the distributed antenna system, the same frequency is generally used between the antennas; therefore, there may be a location (region) in which phases of output radio waves from the antennas are mutually cancelled due to a phase difference. In such a location, communication quality tends to deteriorate as in, for example, deterioration of a throughput or impossibility to establish communication at all.

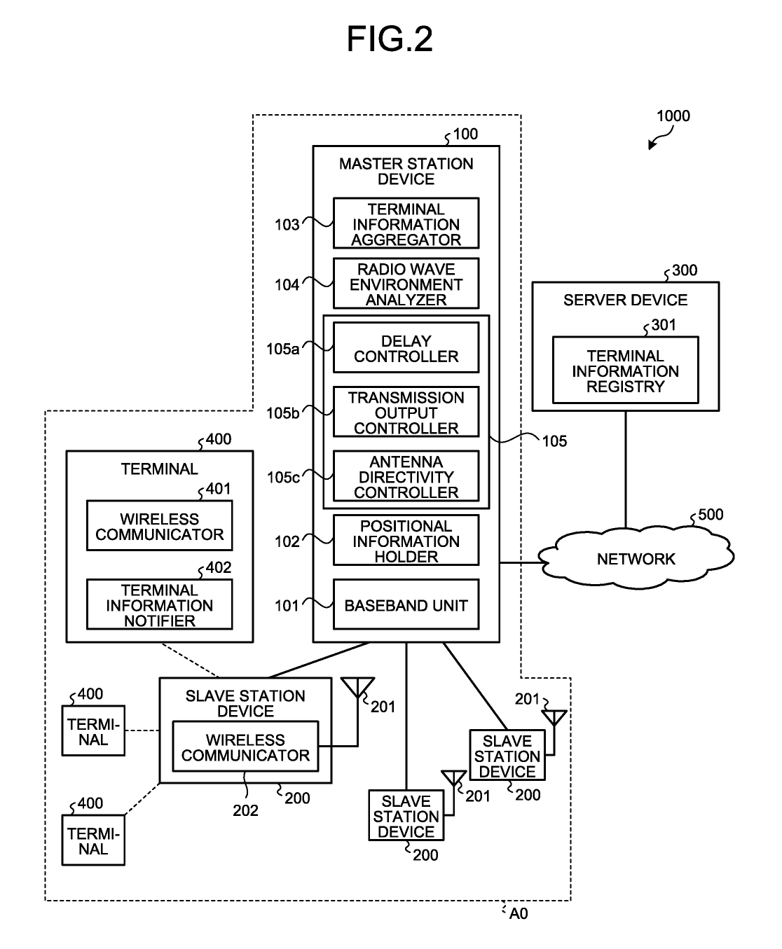

Accordingly, in the first embodiment, the deterioration in communication quality is attempted to be reduced with a configuration illustrated in FIG. 2. Hereinafter, internal configurations of the master station device 100, the slave station device 200, the server device 300, and the terminal 400 in the first embodiment will be more specifically described with reference to FIG. 2. In FIG. 2, configurations related to the master station devices 100B and 100C in FIG. 1 are not illustrated. Accordingly, in FIG. 2, for simplicity, the master station device 100A is illustrated as the master station device 100, the slave station devices 200A to 200C are illustrated as the slave station devices 200, and the terminals 400A to 400C are illustrated as the terminals 400.

As illustrated in FIG. 2, the terminal 400 of the first embodiment includes a wireless communicator 401 and a terminal information notifier 402. The wireless communicator 401 is configured to perform wireless communication with the antenna 201 of the slave station device 200. The terminal information notifier 402 is configured to periodically notify the master station device 100 of terminal information (for example, a terminal ID for identifying the terminal 400) regarding the terminal 400 including the terminal information notifier 402 via the wireless communicator 401.

The slave station device 200 according to the first embodiment includes a wireless communicator 202. The wireless communicator 202 is configured to perform wireless communication using the antenna 201.

The server device 300 of the first embodiment includes a terminal information registry 301. The terminal information registry 301 is configured to receive registration of positional information of the terminals 400 within the predetermined area A0 and to manage a list of the received positional information as first information. The first information is registered, in advance, by an operator person or the like of the communication system 1000, for example, when the terminal 400 is installed.

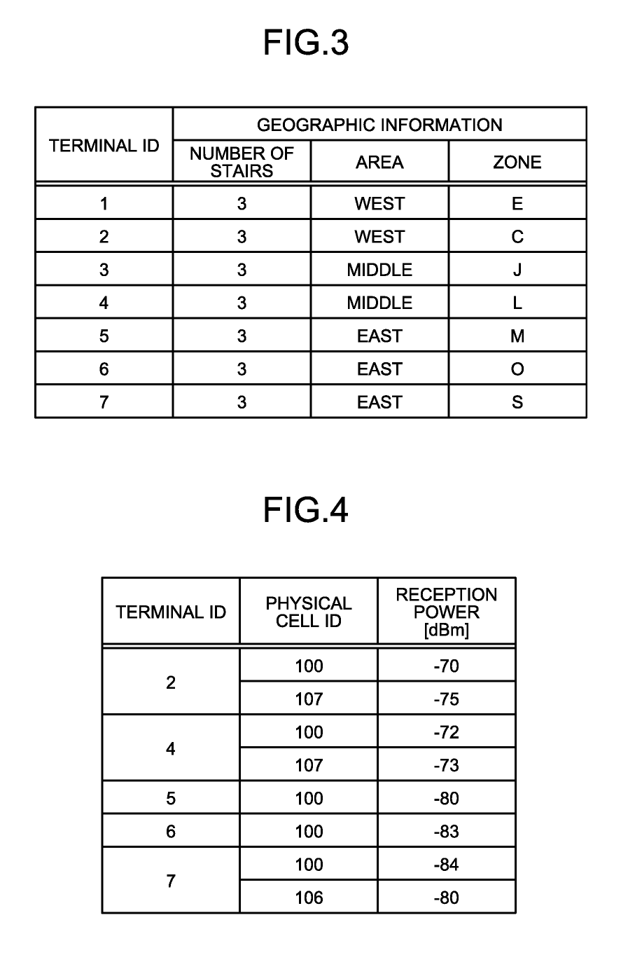

The terminal information registry 301 is configured to manage the first information in the same format as the format illustrated in, for example, FIG. 3. As illustrated in FIG. 3, the terminal information registry 301 is configured to store (manage), for example, a terminal ID for identifying each terminal 400 in association with geographic information (in the example of FIG. 3, the number of stairs of a building, an area, and a zone) for indicating where the terminal 400 identified with the terminal ID is installed within the predetermined area A0.

The master station device 100 according to the first embodiment includes a baseband unit 101, a positional information holder 102, a terminal information aggregator 103, a radio wave environment analyzer 104, and an antenna controller 105. The baseband unit 101 is configured to perform a signal process before modulation or after demodulation on a signal transmitted to and received from the slave station device 200. The positional information holder 102 is configured to receive the first information from the server device 300 (for example, see FIG. 3) and to manage the received first information.

The terminal information aggregator 103 is configured to aggregate and manage predetermined information acquirable from the terminal 400, that is, terminal information (hereinafter referred to as second information) notified from the terminal information notifier 402 of the terminal 400.

The terminal information aggregator 103 is configured to manage the second information in the same format as that illustrated in, for example, FIG. 4. As illustrated in FIG. 4, the terminal information aggregator 103 is configured to store (manage), for example, the terminal ID for identifying the terminal 400 which is an acquisition source of the information, a physical cell ID for identifying the slave device 200 which is used by the terminal 400 identified with the terminal ID at the time of wireless communication, and reception power (unit: dBm) indicating reception strength of information, in association therewith.

The radio wave environment analyzer 104 is configured to analyze the first information (see FIG. 3) managed by the positional information holder 102 and the second information (see FIG. 4) managed by the terminal information aggregator 103, and to specify a terminal located at a position at which communication with the antenna 201 is not possible (hereinafter referred to as an uncommunicable terminal) from among the terminals 400 based on an analysis result.

As described above, the first information is information that is registered in advance by the operator person or the like of the communication system 1000. Therefore, the first information includes positional information (geographic information) of all the terminals 400. On the other hand, the second information is information that is notified by the wireless communication from the terminal information notifier 402 of the terminal 400 to the terminal information aggregator 103 of the master station device 100, as described above. Therefore, when the terminal 400 is installed at an uncommunicable position which may exist in the distributed antenna system, information of the terminal 400 installed at the uncommunicable position is not included in the second information.

Accordingly, the radio wave environment analyzer 104 is configured to compare the first information to the second information and to detect information (terminal ID) which is included in the first information and is not included in the second information. The radio wave environment analyzer 104 is configured to specify the terminal 400 corresponding to the detected terminal ID as the uncommunicable terminal.

When there is the uncommunicable terminal, the antenna controller 105 is configured to perform antenna control of controlling at least one of an output and orientation of the antenna 201 so that the uncommunicable terminal can communicate with the antenna 201. The antenna controller 105 includes a delay controller 105a capable of performing control to delay an output signal (radio wave) from the antenna 201, a transmission output controller 105b capable of performing control to change an output value (a transmission output value) of an output signal from the antenna 201, and an antenna directivity controller 105c capable of performing control to change orientation (directivity) of the antenna 201.

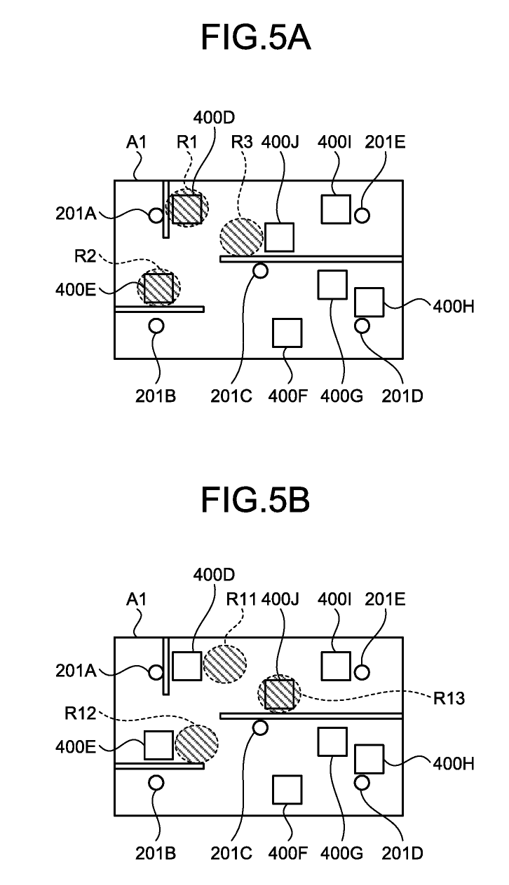

The above-described antenna control is control performed for changing an uncommunicable location (region) which may occurr in the distributed antenna system. According to the antenna control, for example, a radio wave environment illustrated in FIG. 5A is changed to a radio wave environment illustrated in FIG. 5B.

FIGS. 5A and 5B are exemplary diagrams illustrating the radio wave environments before and after the antenna control is performed, respectively. In the examples of FIGS. 5A and 5B, five antennas 201A to 201E and seven terminals 400D to 400J are installed within the predetermined area A1.

In the example of FIG. 5A, three uncommunicable regions R1 to R3 exist within the predetermined area A1. In the example of FIG. 5A, the terminal 400D is located in the uncommunicable region R1 and the terminal 400E is located in the uncommunicable region R2. Accordingly, in the example of FIG. 5A, the terminals 400D and 400E are in an uncommunicable state where communication with the five antennas 201A to 201E is not possible.

On the other hand, in the example of FIG. 5B, as in the example of FIG. 5A, the three uncommunicable regions R11 to R13 exist within the predetermined area A1. The regions R11 to R13 are moved to different positions from the regions R1 to R3 in FIG. 5A through the antenna control. Therefore, in the example of FIG. 5B, the terminals 400D and 400E in the uncommunicable state in the example of FIG. 5A are located at positions except any of the three uncommunicable regions R11 to R13. However, in the example of FIG. 5B, a terminal 400J in a communicable state in the example of FIG. 5A is located within the uncommunicable region R13.

That is, in the example of FIG. 5B, the states of the terminals 400D and 400E in the uncommunicable state in the example of FIG. 5A are changed to the communicable states. However, in the example of FIG. 5B, the state of the terminal 400J in the communicable state in the example of FIG. 5A is changed to the uncommunicable state.

Here, as described above, in the distributed antenna system, the same frequency is used among the antennas in many cases. Accordingly, even when the antenna control is performed, occurrence of the uncommunicable region due to, for example, cancellation of phases is unavoidable in many cases. However, even though the uncommunicable region does not completely disappear, it may be considered that deterioration of communication quality has been suppressed as far as the same terminal 400 is prevented from being in the uncommunicable state for a long time or the number of terminals 400 in the uncommunicable state can be reduced.

Accordingly, in the first embodiment, the antenna controller 105 is configured to repeatedly perform the antenna control at a predetermined time interval. Thus, since the uncommunicable position can be dynamically moved at the predetermined time interval, the same terminal 400 can be prevented from entering the uncommunicable state over a time longer than a predetermined time.

In the first embodiment, the predetermined time interval which is a time period of the antenna control is set to have a value equal to or greater than a sum of an initial connection time and a predetermined communication ensuring time. The initial connection time is a time necessary to establish wireless communication with the antenna 201 after the uncommunicable terminal enters the state in which the communication with the antenna 201 is possible. The predetermined communication ensuring time is a time ensured after the uncommunicable terminal enters the state in which the communication with the antenna 201 is possible. With this configuration, it is possible to ensure a minimum communication time for the terminal 400 entering the communicable state from the uncommunicable state.

In the first embodiment, the time period of the antenna control may be configured to be arbitrarily changeable. For example, the time period of the antenna control may be configured to be automatically changed according to a time zone. In this configuration, for example, the antenna control can be performed at a relatively short time period in a time zone such as the daytime in which communication is frequently performed, and the antenna control can be performed at a relatively long time period in a time zone such as the nighttime in which communication is not frequently performed. Thereby, it is possible to effectively suppress the deterioration in the communication quality according to the time zone.

Meanwhile, in the first embodiment, there is the plurality of antennas 201, as described above. Therefore, in the first embodiment, an “identifier” configured to identify a control target antenna which is a target of the antenna control from the antennas 201 is necessary.

Accordingly, in the first embodiment, the positional information holder 102 of the master station device 100 functions as the “identifier.” That is, the positional information holder 102 according to the first embodiment is configured to identify the control target antenna from the antennas 201 by use of information regarding the uncommunicable terminal specified by the radio wave environment analyzer 104. Hereinafter, an example of a method of identifying the control target antenna will be described more specifically.

As the example of the identifying method, a method (a first method) is considered in which the antenna 201 at a position closest to the uncommunicable terminal is identified as the control target antenna from among the antennas 201 by use of the positional information of the uncommunicable terminal and the antennas 201. The positional information of the antennas 201 may be stored in the server device 300 or may be stored in the master station device 100.

The antenna 201 at the position closest to the uncommunicable terminal is considered to have a large influence on the uncommunicable region in which the uncommunicable terminal is located. Accordingly, when the antenna control is performed on the antenna 201 at the position closest to the uncommunicable terminal, there is a high possibility that the uncommunicable region in which the uncommunicable terminal is located is moved and the uncommunicable terminal enters the communicable state. Therefore, according to the first method, the antenna 201 in which there is a high possibility of the uncommunicable terminal entering the communicable state can be identified as the control target antenna in accordance with a simple method using the positional information.

As another example of the identifying method, a method (a second method) is considered in which a randomly selected antenna 201 is identified as the control target antenna when the number of uncommunicable terminals in a case where the antenna control is performed on the antenna 201 randomly selected from the plurality of antennas 201 is equal to or less than the number of uncommunicable terminals before the antenna control is performed on the randomly selected antenna 201. The antenna control on the randomly selected antenna 201 may be performed as a simulation or may actually be performed.

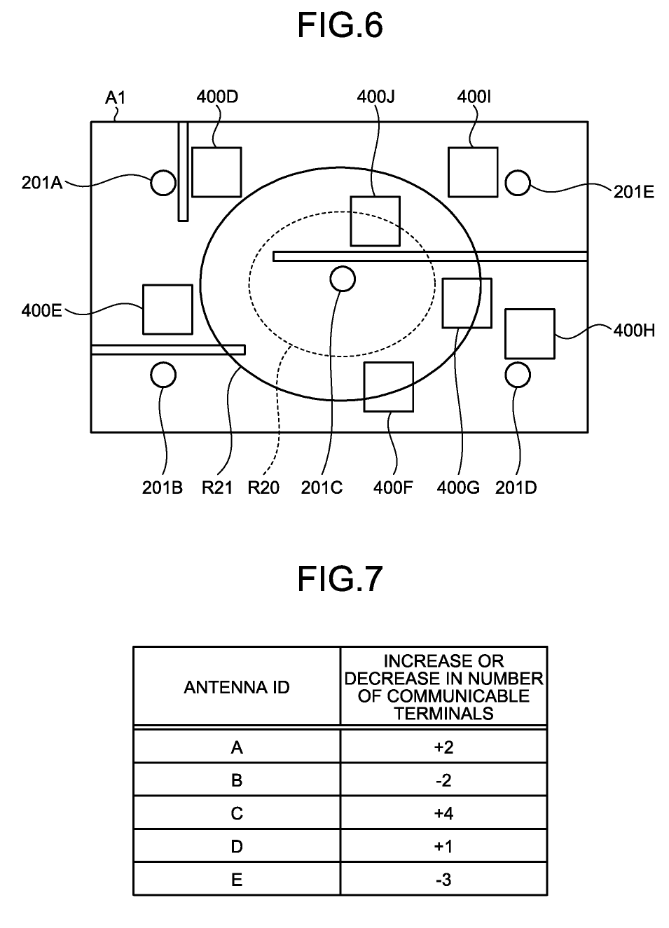

For example, as illustrated in FIG. 6, an antenna 201C is assumed to be selected from five antennas 201A to 201E in accordance with the second method. Then, when the transmission output value of the antenna 201C is changed as a simulation or actually changed, a range in which an output signal from the antenna 201C arrives is assumed to expand from a region R20 to a region R21. In this case, in the second method, the numbers of uncommunicable terminals before and after the change in the transmission output value of the antenna 201C are compared to each other. Then, the antenna 201C is identified as the control target antenna when the number of uncommunicable terminal after the change in the transmission output value of the antenna 201C is less than the number of uncommunicable terminals before the change in the transmission output value of the antenna 201C. According to the second method, it is possible to identify the control target antenna capable of more reliably decreasing the number of uncommunicable terminals.

As a modification example of the second method, a method (a third method) is considered, in which the number of uncommunicable terminals is compared when the antenna control is sequentially performed on the antennas 201 and the antenna 201 for which the number of uncommunicable terminals can be most decreased is identified as the control target antenna.

In the third method, a correspondence relationship between an antenna ID for identifying the antenna 201 and an increase/decrease in the number of communicable terminals 400 when the antenna control is performed on the antenna 201 identified with the antenna ID is recorded with a format illustrated in FIG. 7. Then, the antenna 201 for which the number of communicable terminals 400 is most increased, that is, the number of uncommunicable terminals can be most decreased is identified as the control target antenna. In the example of FIG. 7, the antenna 201 for which the number of communicable terminals 400 is most increased is the antenna 201 of which an antenna ID is C. In the example of FIG. 7, for example, an increase in the number of communicable terminals 400 by 2 is indicated by “+2” and a decrease in the number of communicable terminal 400 by 2 is indicated by “−2.”

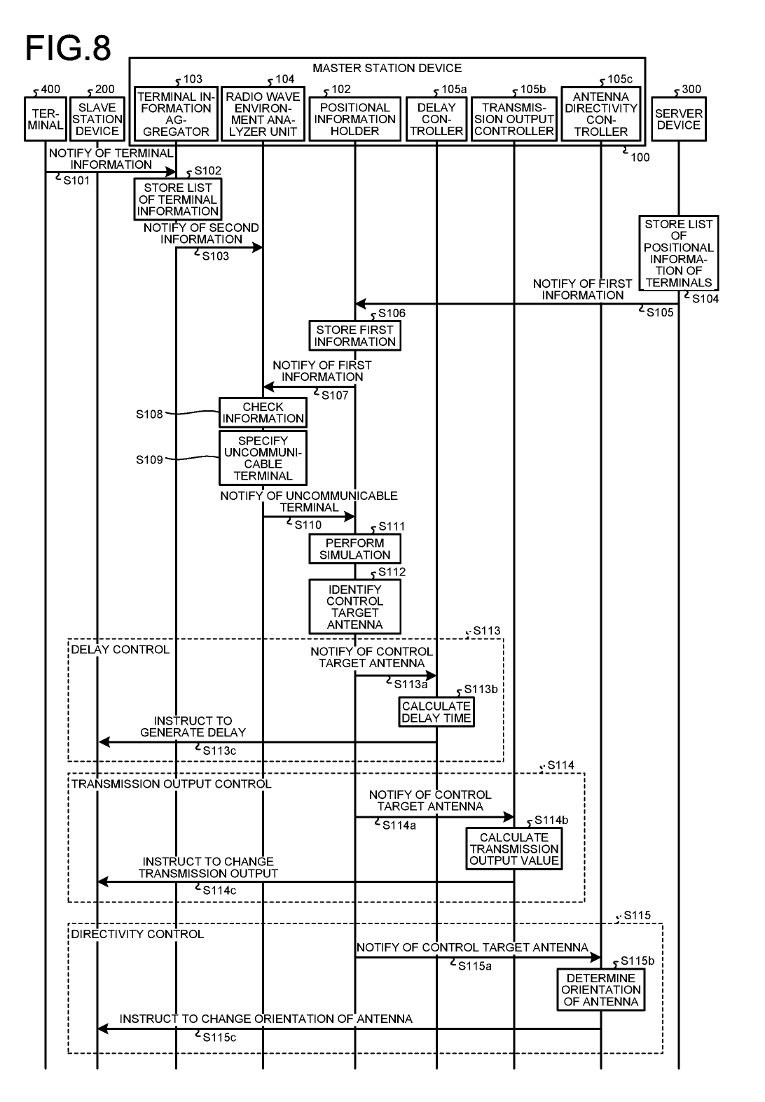

Next, processing performed by the communication system 1000 of the first embodiment will be described with reference to FIG. 8.

As illustrated in FIG. 8, the terminal 400 notifies the master station device 100 of terminal information regarding the terminal 400 (S101). Then, the terminal information aggregator 103 of the master station device 100 stores the list of the terminal information notified from the terminal 400 as the second information (see FIG. 4) (S102). Then, the terminal information aggregator 103 notifies the radio wave environment analyzer 104 of the second information (S103).

On the other hand, the server device 300 receives registration of the positional information of the terminal 400 and stores the list of received the positional information as the first information (see FIG. 3) (S104). Then, the server device 300 notifies the master station device 100 of the stored first information (S105). The positional information holder 102 of the master station device 100 stores the first information notified from the server device 300 (S106). Then, the positional information holder 102 notifies the radio wave environment analyzer 104 of the stored first information (S107).

In the processing of S103 and S107, the radio wave environment analyzer 104 is notified of both the first information and the second information. The radio wave environment analyzer 104 checks the first information against the second information (S108) and specifies the uncommunicable terminal (S109). Then, the radio wave environment analyzer 104 notifies the positional information holder 102 of the information regarding the specified uncommunicable terminal (S110).

The positional information holder 102 performs simulation based on the information regarding the uncommunicable terminal notified from the radio wave environment analyzer 104 (S111), and then identifies a control target antenna (S112). Then, the positional information holder 102 notifies one or more of the delay controller 105a, the transmission output controller 105b, and the antenna directivity controller 105c of information regarding the identified control target antenna.

When the information regarding the control target antenna is transmitted from the positional information holder 102 to the delay controller 105a, delay control is performed (S113). That is, when the delay control is performed, the positional information holder 102 first notifies the delay controller 105a of the information regarding the control target antenna (S113a). Then, the delay controller 105a calculates a delay time to be set in the control target antenna (S113b). Then, the delay controller 105a instructs the slave station device 200 including the control target antenna to generate delay based on the calculated delay time (S113c). Thus, an uncommunicable position that may occur in the distributed antenna system is moved, and the delay control then ends.

When the information regarding the control target antenna is transmitted from the positional information holder 102 to the transmission output controller 105b, transmission output control is performed (S114). That is, when the transmission output control is performed, the positional information holder 102 notifies the transmission output controller 105b of the information regarding the control target antenna (S114a). Then, the transmission output controller 105b calculates a transmission output value to be set in the control target antenna (S114b). Then, the transmission output controller 105b instructs the slave station device 200 including the control target antenna to change a transmission output based on the calculated transmission output value (S114c). Thus, the uncommunicable position that may occur in the distributed antenna system is moved, and the transmission output control then ends.

When the information regarding the control target antenna is transmitted from the positional information holder 102 to the antenna directivity controller 105c, directivity control is performed (S115). That is, when the directivity control is performed, the positional information holder 102 first notifies the antenna directivity controller 105c of the information regarding the control target antenna (S115a). Then, the antenna directivity controller 105c determines orientation (direction) to be set in the control target antenna (S115b). Then, the antenna directivity controller 105c instructs the slave station device 200 including the control target antenna to change the orientation based on the determined orientation (S115c). Thus, the uncommunicable position that may occur in the distributed antenna system is moved, and the directivity control then ends.

In the first embodiment, as far as the uncommunicable position that may occur in the distributed antenna system can be moved, three processing of S113 to S115 may be selectively performed or two or more processing among the three processing of S113 to S115 may be simultaneously or continuously performed.

As described above, the master station device 100 of the communication system 1000 according to the first embodiment includes the radio wave environment analyzer 104 and the antenna controller 105 that have the following configurations. The radio wave environment analyzer 104 is configured to analyze the first information (see FIG. 3) and the predetermined second information (see FIG. 4), and to specify an uncommunicable terminal from among the terminals 400 based on an analysis result. The first information is information that is registered in advance as the positional information of terminals 400 within the predetermined area A0. The second information is information that is acquirable from the terminals 400. The uncommunicable terminal is one of the terminals 400 that is located at a position where communication with the antenna 201 is not possible. The antenna controller 105 is configured to perform the antenna control of controlling at least one of an output and orientation of the antenna 201 when there is the uncommunicable terminal, so that the uncommunicable terminal enters a state in which communication with the antenna 201 is possible. Thus, it is possible to suppress deterioration in the communication quality in the distributed antenna system.

### Second Embodiment

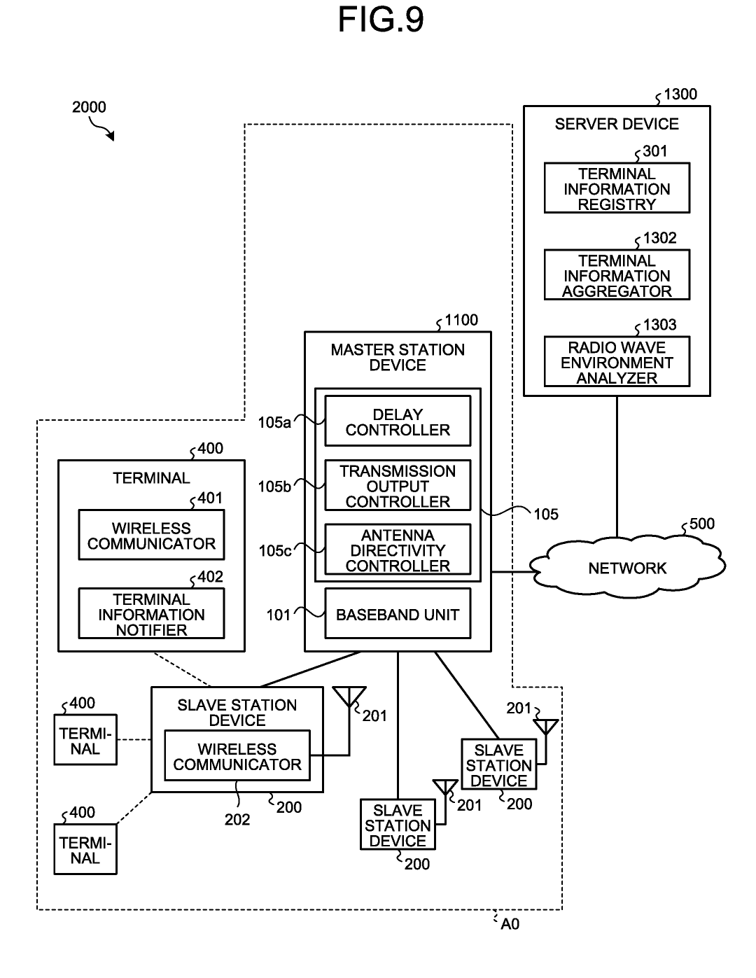

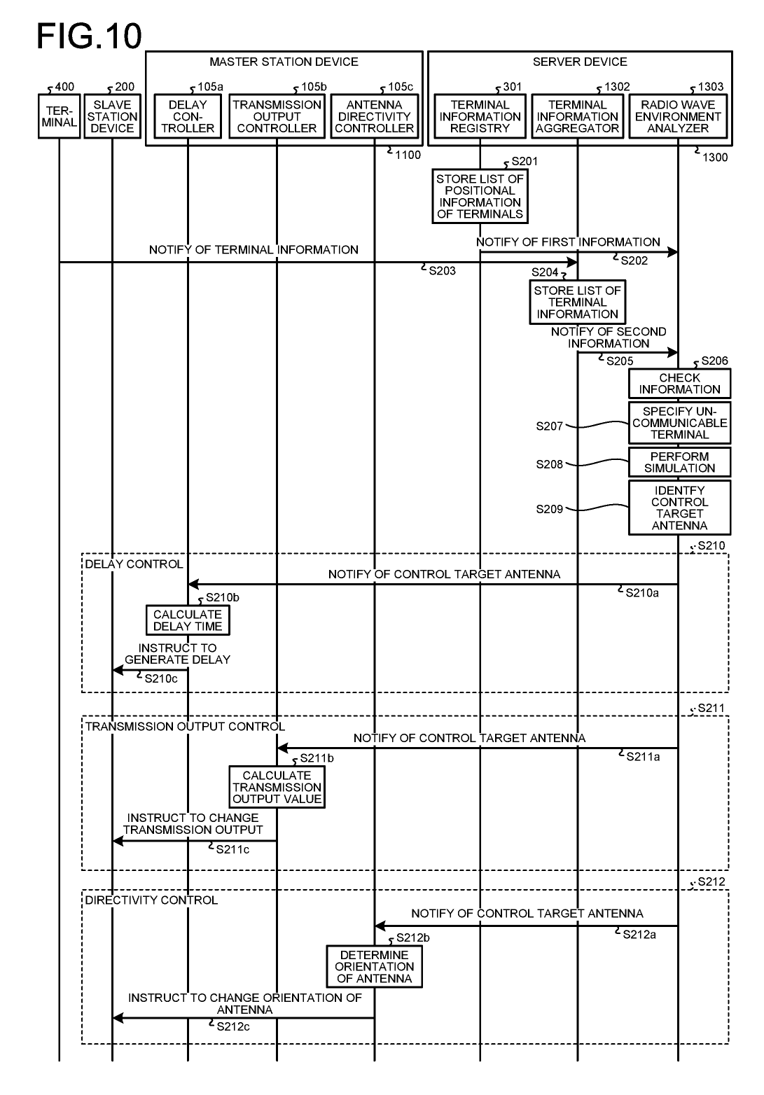

Next, a communication system 2000 according to a second embodiment will be described with reference to FIGS. 9 and 10. In the second embodiment, unlike the first embodiment in which both of the configurations corresponding to an “analyzer” and a “controller” are provided in the master station device 100 (see FIG. 2), configurations corresponding to the “analyzer” and the “controller” are separated to be provided in a server device 1300 and a master station device 1100, respectively.

That is, as illustrated in FIG. 9, in the second embodiment, an antenna controller 105 serving as the “controller” that performs antenna control is provided in the master station device 1100, and a radio wave environment analyzer 1303 serving as an “analyzer” that specifies an uncommunicable terminal is provided in the server device 1300.

The radio wave environment analyzer 1303 of the second embodiment functions not only as the “analyzer” that specifies the uncommunicable terminal but also as an “identifier” that identifies a control target antenna. That is, the radio wave environment analyzer 1303 of the second embodiment specifies an uncommunicable terminal from among the terminals 400 and identifies a control target antenna from among the antennas 201 based on the first information (see FIG. 3) and the second information (see FIG. 4). The first information is a list of positional information of the terminals 400 registered in advance. The second information is a list of terminal information collected from the terminals 400.

In the second embodiment, the first information is managed by the terminal information registry 301 of the server device 1300, and the second information is managed by a terminal information aggregator 1302 of the server device 1300. That is, in the second embodiment, unlike the first embodiment in which the terminal information aggregator 103 managing the second information is provided in the master station device 100 (see FIG. 2), the terminal information aggregator 1302 managing the second information is provided in the server device 1300. The radio wave environment analyzer 1303 of the second embodiment specifies the uncommunicable terminal and identifies the control target antenna by using the first information notified from the terminal information registry 301 and the second information notified from the terminal information aggregator 1302. The antenna controller 105 of the master station device 1100 of the second embodiment perform antenna control so that the uncommunicable terminal enters a communicable state based on information regarding the control target antenna notified from the radio wave environment analyzer 1303.

The rest of configuration of the second embodiment is the same as that of the first embodiment.

Next, processing performed by each device included in the communication system 2000 of the second embodiment will be described with reference to FIG. 10.

As illustrated in FIG. 10, the terminal information registry 301 of the server device 1300 receives registration of the positional information of the terminal 400 and stores the list of the received positional information as the first information (S201). Then, the server device 1300 notifies the radio wave environment analyzer 1303 of the stored first information (S202).

On the other hand, the terminal 400 notifies the server device 1300 the terminal information regarding the terminal 400 itself (S203). Then, the terminal information aggregator 1302 of the server device 1300 stores the list of the terminal information notified from the terminal 400 as the second information (S204). Then, the terminal information aggregator 1302 notifies the radio wave environment analyzer 1303 of the second information (S205).

In the processing of S202 and S205, the radio wave environment analyzer 1303 is notified of both the first information and the second information. The radio wave environment analyzer 1303 checks the first information against the second information (S206), and then specifies the uncommunicable terminal (S207). Then, the radio wave environment analyzer 1303 performs simulation based on the information regarding the specified uncommunicable terminal (S208), and then identifies a control target antenna (S209). Then, the radio wave environment analyzer 1303 notifies one or more of the delay controller 105a, the transmission output controller 105b, and the antenna directivity controller 105c of the master station device 1100 of information regarding the specified control target antenna.

When the information regarding the control target antenna is transmitted from the radio wave environment analyzer 1303 to the delay controller 105a, delay control is performed (S210). That is, when the delay control is performed, the radio wave environment analyzer 1303 first notifies the delay controller 105a of the information regarding the control target antenna (S210a). Then, the delay controller 105a calculates a delay time to be set in the control target antenna (S210b). Then, the delay controller 105a instructs the slave station device 200 including the control target antenna to generate delay based on the calculated delay time (S210c). Thus, an uncommunicable position that may occur in the distributed antenna system is moved, and the delay control then ends.

When the information regarding the control target antenna is transmitted from the radio wave environment analyzer 1303 to the transmission output controller 105b, transmission output control is performed (S211). That is, when the transmission output control is performed, the radio wave environment analyzer 1303 first notifies the transmission output controller 105b of the information regarding the control target antenna (S211a). Then, the transmission output controller 105b calculates a transmission output value to be set in the control target antenna (S211b). Then, the transmission output controller 105b instructs the slave station device 200 including the control target antenna to change a transmission output based on the calculated transmission output value (S211c). Thus, the uncommunicable position that may occur in the distributed antenna system is moved, and the transmission output control then ends.

When the information regarding the control target antenna is transmitted from the radio wave environment analyzer 1303 to the antenna directivity controller 105c, directivity control is performed (S212). That is, when the directivity control is performed, the radio wave environment analyzer 1303 first notifies the antenna directivity controller 105c of the information regarding the control target antenna (S212a). Then, the antenna directivity controller 105c determines orientation (direction) to be set in the control target antenna (S212b). Then, the antenna directivity controller 105c instructs the slave station device 200 including the control target antenna to change the orientation based on the determined orientation (S212c). Thus, the uncommunicable position that may occur in the distributed antenna system is moved, and the directivity control then ends.

Similarly to the first embodiment, in the second embodiment, as far as the uncommunicable position that may occur in the distributed antenna system can be moved, three processing of S210 to S212 may be selectively performed or two or more processing among the three processing of S210 to S212 may be simultaneously or continuously performed.

As described above, in the second embodiment, the radio wave environment analyzer 1303 that is configured similarly to the radio wave environment analyzer 104 of the first embodiment is provided in the server device 1300. In the second embodiment, similarly to the first embodiment, the antenna controller 105 is provided in the master station device 1100. Accordingly, in the second embodiment, the same advantages as those of the first embodiment can be attained by use of the radio wave environment analyzer 1303 provided in the server device 1300 and the antenna controller 105 provided in the master station device 1100. Thus, in the second embodiment, similarly to the first embodiment, it is possible to suppress deterioration in the communication quality in the distributed antenna system.

### Third Embodiment

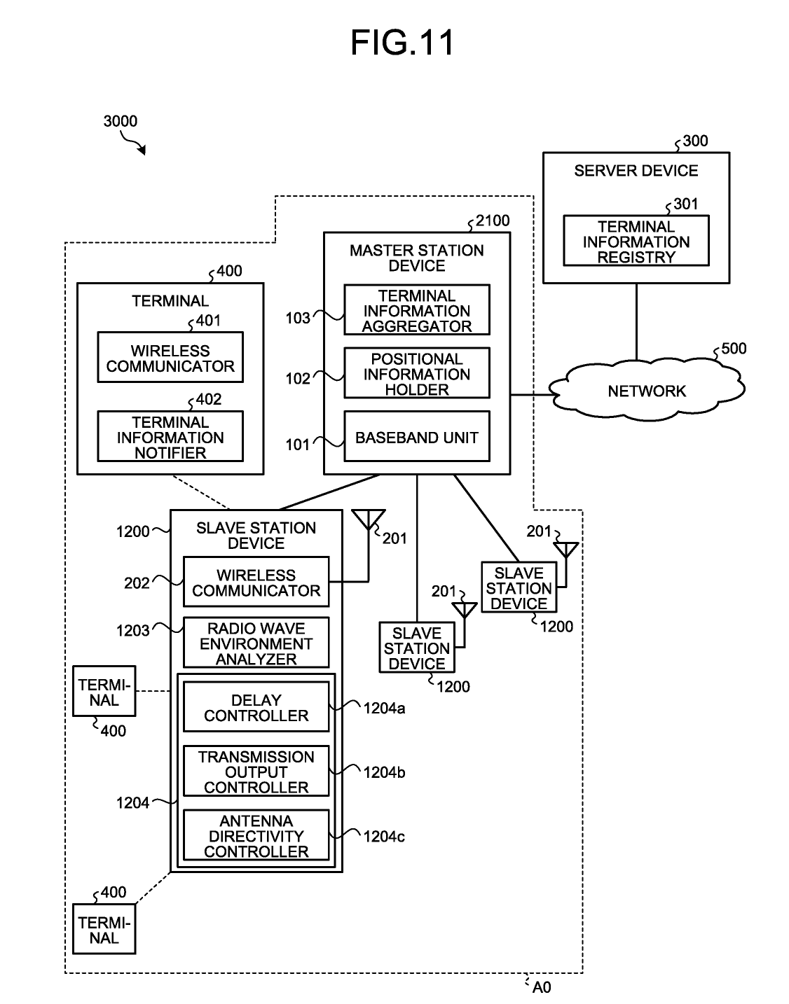

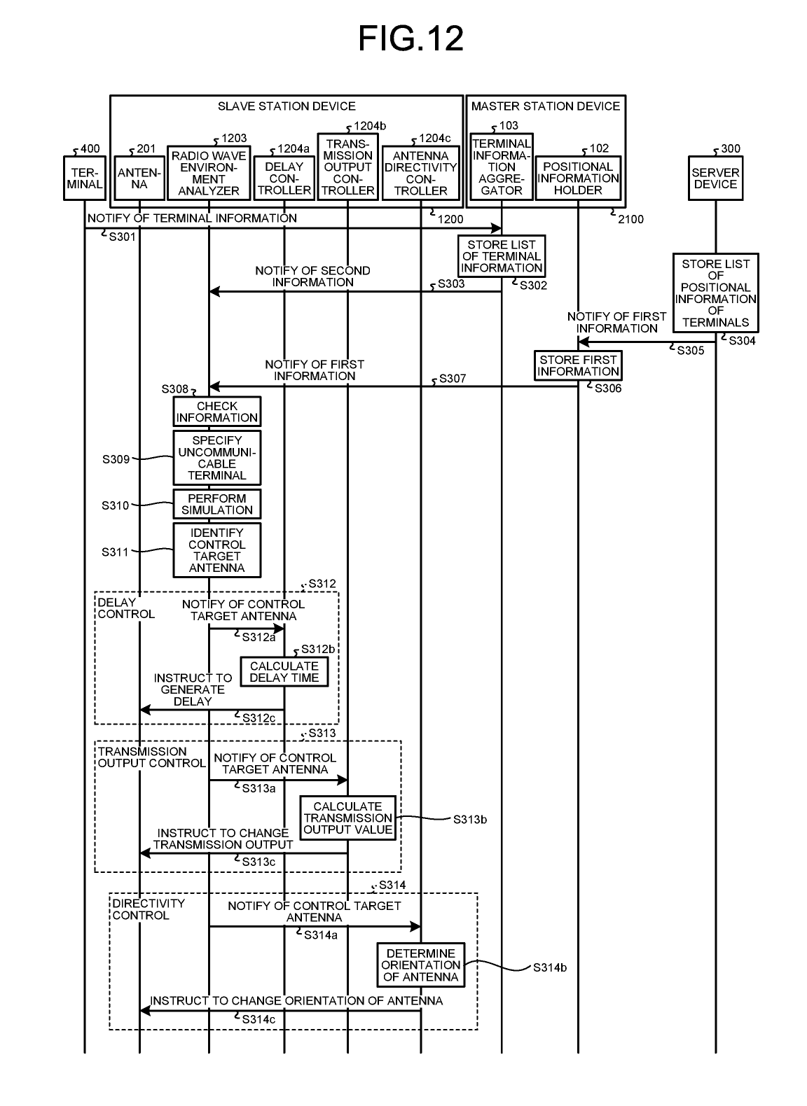

Next, a communication system 3000 according to a third embodiment will be described with reference to FIGS. 11 and 12. In the third embodiment, unlike the first embodiment in which both of the configurations corresponding to an “analyzer” and a “controller” are provided in the master station device 100 (see FIG. 2), both configurations corresponding to the “analyzer” and the “controller” are provided in a slave station device 1200.

That is, as illustrated in FIG. 11, in the third embodiment, a radio wave environment analyzer 1203 serving as a “analyzer” that specifies an uncommunicable terminal, and an antenna controller 1204 serving as a “controller” that performs antenna control is provided in the slave station device 1200.

The radio wave environment analyzer 1203 of the third embodiment functions not only as the “analyzer” that specifies the uncommunicable terminal but also as an “identifier” that identifies a control target antenna. That is, the radio wave environment analyzer 1203 of the third embodiment specifies an uncommunicable terminal from the terminals 400 and identifies a control target antenna from the antennas 201 based on the first information (see FIG. 3) and the second information (see FIG. 4). The first information is a list of positional information of the terminals 400 registered in advance. The second information is a list of terminal information collected from the terminals 400.

In the third embodiment, similarly to the first embodiment, the first information is managed by the terminal information registry 301 of the server device 300 and the positional information holder 102 of a master station device 2100, and the second information is managed by the terminal information aggregator 103 of the master station device 2100. Accordingly, the radio wave environment analyzer 1203 of the third embodiment specifies the uncommunicable terminal and identifies the control target antenna by using the first information notified from the terminal information registry 301 via the positional information holder 102 and the second information notified from the terminal information aggregator 103. A delay controller 1204a, a transmission output controller 1204b, and an antenna directivity controller 1204c of the antenna controller 1204 of the third embodiment perform antenna control so that the uncommunicable terminal enters a communicable state based on information regarding the control target antenna notified from the radio wave environment analyzer 1203.

The rest of configuration of the third embodiment is the same as that of the first embodiment.

Next, processing performed by each device included in the communication system 3000 of the third embodiment will be described with reference to FIG. 12.

As illustrated in FIG. 12, the terminal 400 notifies the master station device 2100 of terminal information regarding the terminal 400 (S301). Then, the terminal information aggregator 103 of the master station device 2100 stores the list of the terminal information reported from the terminal 400 as the second information (S302). Then, the terminal information aggregator 103 notifies the radio wave environment analyzer 1203 of the slave station device 1200 of the second information (S303).

On the other hand, the server device 300 receives registration of the positional information regarding the terminal 400, and then stores the list of received the positional information as the first information (S304). Then, the server device 300 notifies the master station device 2100 of the stored first information (S305). The positional information holder 102 of the master station device 2100 stores the first information notified from the server device 300 (S306). Then, the positional information holder 102 notifies the radio wave environment analyzer 1203 of the slave station device 1200 of the stored first information (S307).

In the processing of S303 and S307, the radio wave environment analyzer 1203 is notified of both the first information and the second information. The radio wave environment analyzer 1203 checks the first information against the second information (S308), and then specifies the uncommunicable terminal (S309). Then, the radio wave environment analyzer 1203 performs simulation based on the information regarding the specified uncommunicable terminal (S310), and then identifies a control target antenna (S311). Then, the radio wave environment analyzer 1203 notifies one or more of the delay controller 1204a, the transmission output controller 1204b, and the antenna directivity controller 1204c of information regarding the identified control target antenna.

When the information regarding the control target antenna is transmitted from the radio wave environment analyzer 1203 to the delay controller 1204a, delay control is performed (S312). That is, when the delay control is performed, the radio wave environment analyzer 1203 first notifies the delay controller 1204a of the information regarding the control target antenna (S312a). Then, the delay controller 1204a calculates a delay time to be set in the control target antenna (S312b). Then, the delay controller 1204a instructs the control target antenna to generate delay based on the calculated delay time (S312c). Thus, an uncommunicable position that may occur in the distributed antenna system is moved, and the delay control then ends.

When the information regarding the control target antenna is transmitted from the radio wave environment analyzer 1203 to the transmission output controller 1204b, transmission output control is performed (S313). That is, when the transmission output control is performed, the radio wave environment analyzer 1203 first notifies the transmission output controller 1204b of the information regarding the control target antenna (S313a). Then, the transmission output controller 1204b calculates a transmission output value to be set in the control target antenna (S313b). Then, the transmission output controller 1204b instructs the control target antenna to change a transmission output based on the calculated transmission output value (S313c). Thus, the uncommunicable position that may occur in the distributed antenna system is moved, and the transmission output control then ends.

When the information regarding the control target antenna is transmitted from the radio wave environment analyzer 1203 to the antenna directivity controller 1204c, directivity control is performed (S314). That is, when the directivity control is performed, the radio wave environment analyzer 1203 first notifies the antenna directivity controller 1204c of the information regarding the control target antenna (S314a). Then, the antenna directivity controller 1204c determines orientation (direction) to be set in the control target antenna (S314b). Then, the antenna directivity controller 1204c instructs the control target antenna to change the orientation based on the determined orientation (S314c). Thus, the uncommunicable position that may occur in the distributed antenna system is moved, and the directivity control then ends.

Similarly to the first embodiment, in the third embodiment, as far as the uncommunicable position that may occur in the distributed antenna system can be moved, three processing of S312 to S314 may be selectively performed or two or more processing among the three processing of S312 to S314 may be simultaneously or continuously performed.

As described above, in the third embodiment, the radio wave environment analyzer 1203 and the antenna controller 1204 that are configured similarly to the radio wave environment analyzer 104 and the antenna controller 105 of the first embodiment are provided in the slave station device 1200. Accordingly, in the third embodiment, the same advantages as those of the first embodiment can be attained by use of the radio wave environment analyzer 1203 and the antenna controller 1204 provided in the slave station device 1200. Thus, in the third embodiment, similarly to the first embodiment, it is possible to suppress deterioration in the communication quality in the distributed antenna system.

### Modification Examples

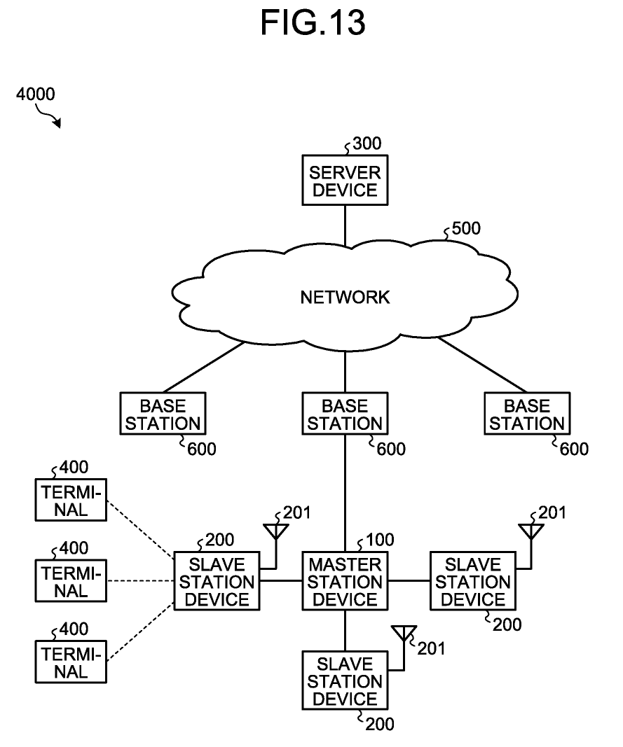

As described above, the technique for suppressing the deterioration in the communication quality in the communication system in which the master station device is directly connected to the network has been described. However, the foregoing technique can also be applied to a communication system 4000 in which a master station device 100 is connected to a network 500 via base stations 600 as in a modification example illustrated in FIG. 13.

Further, in the above description, the cancellation of the phases of the output signals (radio waves) from the antennas installed within the same area has been exemplified as an occurring factor of the uncommunicable position (region) in the distributed antenna system. However, in the distributed antenna system, an uncommunicable position may also occur due to interference with an output signal from an antenna provided in another area (for example, an adjacent area). According to the technique of the embodiments, the uncommunicable position due to the interference can also be dynamically moved, and it is possible to suppress the deterioration in the communication quality.

In addition, the example has been described above in which the configuration corresponding to the “analyzer” that specifies an uncommunicable terminal and the configuration corresponding to the “controller” that performs the antenna control are provided in any one of the master station device, the slave station device, and the server device. However, the configurations corresponding to the “analyzer” and the “controller” may be duplicately provided in two or more of the master station device, the slave station device, and the server device.

While certain embodiments and modification examples of the present invention have been described, these embodiments and modification examples have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A communication system that is configured to manage wireless communication via an antenna capable of communicating with a plurality of terminals within a predetermined area, the communication system comprising:
an analyzer configured to analyze first information and second information and to specify an uncommunicable terminal from the terminals based on an analysis result, the first information being information registered in advance as positional information of the terminals within the predetermined area, the second information being predetermined information acquirable from the terminals, the uncommunicable terminal being a terminal located at a position where communication with the antenna is not possible; and
a controller configured to perform antenna control of controlling at least one of an output and orientation of the antenna when there is the uncommunicable terminal, so that the uncommunicable terminal enters a state in which the communication with the antenna is possible.

2. The communication system according to claim 1, wherein
the controller repeatedly performs the antenna control at a predetermined time interval.

3. The communication system according to claim 2, wherein
the predetermined time interval is set to have a value equal to or greater than a sum of an initial connection time and a communication ensuring time, the initial connection time being a time necessary to establish the wireless communication with the antenna after the uncommunicable terminal enters the state in which the communication with the antenna is possible, the communication ensuring time being a predetermined time ensured after the uncommunicable terminal enters the state in which the communication with the antenna is possible.

4. The communication system according to claim 1, further comprising
an identifier configured to identify, when there is a plurality of antennas, a control target antenna which is a target of the antenna control from among the antennas by use of information regarding the uncommunicable terminal.

5. The communication system according to claim 4, wherein
the identifier is configured to identify an antenna at a position closest to the uncommunicable terminal as the control target antenna from among the antennas by use of positional information of the uncommunicable terminal and positional information of the antennas.

6. The communication system according to claim 4, wherein
when the number of uncommunicable terminals in a case where the antenna control is performed on an antenna randomly selected from among the antennas is equal to or less than the number of uncommunicable terminals before the antenna control is performed on the randomly selected antenna, the identifier is configured to identify the randomly selected antenna as the control target antenna.

7. The communication system according to claim 1, further comprising:
a master station device; and
a slave station device that is connected to the master station device and comprises the antenna, wherein
the analyzer and the controller are comprised in at least one of the master station device and the slave station device.

8. The communication system according to claim 1, further comprising:
a master station device;
a slave station device that is connected to the master station device and comprises the antenna; and
a server device that is connected to the master station device via a network and configured to manage the first information, wherein
the analyzer and the controller are comprised in at least one of the master station device, the slave station device, and the server device.

9. A master station device that is connected to a slave station device including an antenna capable of communicating with a plurality of terminals within a predetermined area, the master station device comprising:
an analyzer configured to analyze first information and second information and to specify an uncommunicable terminal from the terminals based on an analysis result, the first information being information registered in advance as positional information of the terminals within the predetermined area, the second information being predetermined information acquirable from the terminals, the uncommunicable terminal being a terminal located at a position where communication with the antenna is not possible; and
a controller configured to perform antenna control of controlling at least one of an output and orientation of the antenna when there is the uncommunicable terminal, so that the uncommunicable terminal enters a state in which the communication with the antenna is possible.

10. A communication control method that is performed by a communication system configured to manage wireless communication via an antenna capable of communicating with a plurality of terminals within a predetermined area, the method comprising:
analyzing first information and second information, the first information being information registered in advance as positional information of the terminals within the predetermined area, the second information being predetermined information acquirable from the terminals;
specifying an uncommunicable terminal from the terminals based on an analysis result, the uncommunicable terminal being a terminal located at a position where communication with the antenna is not possible; and
performing antenna control of controlling at least one of an output and orientation of the antenna when there is the uncommunicable terminal, so that the uncommunicable terminal enters a state in which the communication with the antenna is possible.

11. The communication control method according to claim 10, wherein
the antenna control is repeatedly performed at a predetermined time interval.

12. The communication control method according to claim 11, wherein
the predetermined time interval is set to have a value equal to or greater than a sum of an initial connection time and a communication ensuring time, the initial connection time being a time necessary to establish the wireless communication with the antenna after the uncommunicable terminal enters the state in which the communication with the antenna is possible, the communication ensuring time being a predetermined time ensured after the uncommunicable terminal enters the state in which the communication with the antenna is possible.

13. The communication control method according to claim 10, further comprising
identifying, when there is a plurality of antennas, a control target antenna which is a target of the antenna control from among a plurality of antennas by use of information regarding the uncommunicable terminal.

14. The communication control method according to claim 13, wherein
an antenna at a position closest to the uncommunicable terminal is identified as the control target antenna from among the antennas by use of positional information of the uncommunicable terminal and positional information of the of antennas.

15. The communication control method according to claim 13, wherein
when the number of uncommunicable terminals in a case where the antenna control is performed on an antenna randomly selected from among the antennas is equal to or less than the number of uncommunicable terminals before the antenna control is performed on the randomly selected antenna, the randomly selected antenna is identified as the control target antenna.
